(19) United States
(12) Patent Application Publication
(10) Pub. No.: US 2007/0048870 A1
(43) Pub. Date: Mar. 1, 2007

(54) Endohedral fullerenes as spin labels and MRI contrast agents

(75) Inventors: Xiao Dong Xiang, Danville, CA (US); Haitao Yang, Albany, CA (US); Gerald F. Dionne, Winchester, MA (US)

Correspondence Address: QUINE INTELLECTUAL PROPERTY LAW GROUP, P.C., P O BOX 458, ALAMEDA, CA, 94501, US

(73) Assignee: Intematix Corporation

(21) Appl. No.: 11/351,312

(22) Filed: Feb. 8, 2006

Related U.S. Application Data
(60) Provisional application No. 60/652,288, filed on Feb. 10, 2005.

(51) Int. Cl. G01N 37/00

(52) U.S. Cl. 436/56; 423/445 B; 977/736

(57) ABSTRACT

This invention pertains to the discovery that certain endohedral fullerenes are functional paramagnetic materials exhibiting increased relaxation times. These endohedral fullerenes provide improved labels for use in electron spin resonance (ESR) detection systems.

### CROSS-REFERENCE TO RELATED APPLICATIONS

This application claims priority to and benefit of U.S. Ser. No. 60/652,288, filed Feb. 10, 2005, which is incorporated herein by reference in its entirety for all purposes.

### STATEMENT AS TO RIGHTS TO INVENTIONS MADE UNDER FEDERALLY SPONSORED RESEARCH AND DEVELOPMENT

[Not Applicable]

### FIELD OF THE INVENTION

This invention is related to the development of a new class of electron spin labels that can be used in a variety of imaging applications, e.g., as MRI contrast agents, as as bioreporters, and the like. In particular, in certain embodiments, this invention provides paramagnetic endofullerenes that can be detected using electron spin resonance techniques.

### BACKGROUND OF THE INVENTION

There are a variety of imaging techniques that have been used to diagnose disease and/or to investigate basic biological processes in humans and other mammals, and/or in various in vitro assays. One of the first imaging techniques employed was X-rays. X-rays, produced images of the subject's body reflecting the different densities of structures within the organism. To improve the diagnostic utility of this imaging technique, contrast agents have been employed to increase the density between various structures, such as between the gastrointestinal tract and its surrounding tissues. Barium and iodinated contrast media, for example, are used extensively for X-ray gastrointestinal studies to visualize the esophagus, stomach, intestines and rectum. Likewise, these contrast agents are used for X-ray computed tomographic studies to improve visualization of the gastrointestinal tract and to provide, for example, a contrast between the tract and the structures adjacent to it, such as the vessels or lymph nodes. Such gastrointestinal contrast agents permit one to increase their density inside the esophagus, stomach, intestines and rectum, and allow differentiation of the gastrointestinal system from surrounding structures.

Magnetic resonance imaging (MRI) is a relatively new imaging technique which, unlike X-rays, does not utilize ionizing radiation. Like computed tomography, MRI can make cross-sectional images of the body, however MRI has the additional advantage of being able to make images in any scan plane (i.e., axial, coronal, sagittal or orthogonal). MRI employs a magnetic field, radiofrequency energy and magnetic field gradients to make images of the body. The contrast or signal intensity differences between tissues mainly reflect the T₁ and T₂ relaxation values and the proton density (effectively, the free water content) of the tissues. In changing the signal intensity in a region of a patient by the use of a contrast medium, several possible approaches are available. For example, a contrast medium can be designed to change either the T₁, the T₂ of the proton. A contrast agent could also work by altering the proton density, specifically by decreasing the amount of free water available that gives rise to the signal intensity. Unfortunately, the existing MRI contrast agents all suffer from a number of limitations, particularly when employed as oral gastrointestinal agents.

Other reporters that have been used in in vivo and in in vitro assays include, but are not limited to enzymes, radioisotopes, and fluorescent dye molecules. These reporters also pose a number of problems. For example, radioisotopes create radiation hazards, waste disposal problems and are highly regulated. Multi-color luminescence or fluorescence reporters are not useful in vivo, and in vitro, they often have the problem of photo bleaching and their detestability is significantly lowered in fluorescent matrices. Enzymes require careful timing of reactions, do not offer multiplex capability and are not compatible with microscopic formats.

Spin label ESR and NMR spectroscopy are very powerful tools to determine three-dimensional protein structures, to analyze protein-ligand interaction, and the like. Unlike X-ray structural determinations, these techniques do not require protein crystal growth. In addition, protein structure can be resolved under physiologically relevant conditions. Electron paramagnetic resonance (EPR) spectroscopy of site-directed spin label (SDSL) on proteins can reveal protein motion and determine protein structures of any size. Compare to fluorescence spectroscopy techniques, in which fluorescent tags are attached to protein, spin labels are much smaller and less likely to interfere with the protein's native structure and movement. In addition, spin label-EPR technique is more sensitive and require less protein than NMR technique.

Spin labels have also been used as relaxation enhancers for protein-ligand interaction screening using NMR spectroscopy. The advantages of NMR spectroscopy screening are its high sensitivity for even weak binding interactions, robustness for not producing false positives, the potential to obtain structural information of the binding interaction and the ability to identify and structurally characterize the binding of two or more ligands at the same time. However, the most important draw back of NMR screening is the low sensitivity of currently available instrument and the lack of surface scanning capability for spatially addressable libraries.

In techniques such as nuclear magnetic resonance (NMR) and electron spin resonance (ESR), it is the absorption of electromagnetic radiation (RF or microwave) needed to flip proton spins or electron spins that is detected. The frequency v (actually spectrum of frequencies) of the absorbed radiation provides information about the material's composition and structure. A major limitation of these techniques is that the strength of the absorption depends upon the spin population difference in the material. The fractional difference in the population n distributed between the two energy levels split by a magnetic field H is governed by Boltzmann statistics. For quantum energies h v that are much smaller than the thermal energy kT, it can be approximated by

$$\frac{Δ n}{n} = \frac{1}{2} \frac{γ H}{kT} = \frac{1}{2} \frac{h ν}{kT} \qquad I$$

where h is Planck's constant and γ is the gyromagnetic constant that is proportional to the particle mass.

This has a profound effect on the sensitivity of detection. In NMR case, since the highest magnetic field H available is limited to ˜20 Tesla, the highest frequency to excite the nuclear spin resonance is limited to below 1 GHz, which gives quite small population difference at room temperature (˜10⁻⁴). However, because of the difference in electron and proton masses, in ESR γ is about 2000 times greater and the frequency for resonance can be increased up to three orders of magnitude for the same strength of magnetic field. Consequently a much higher spin population difference is achievable at room temperature using ESR methods (e.g., ESR spectroscopy). This dramatically increases the sensitivity of ESR methods which are presently limited by population differences. Even for commonly used 10 GHz frequency, the gain in sensitivity due to population difference is nearly two orders of magnitude over NMR.

However, the problem in ESR spectroscopy is the short relaxation time or broad spectrum peak of electron spin resonance. Usually, the electron wave functions in solids are sufficiently overlapped to cause spins of individual electrons to be disturbed or quenched by the electrostatic fields of the surrounding environment. Since random noise is distributed over broad frequency spectrum, signal to noise ratio or sensitivity can be dramatically degraded in broad peak detection. Furthermore, short relaxation time increases the difficulty or prevents the adoption of time resolved pulse technique widely and successfully used in NMR spectroscopy. These two reasons explain why ESR technique has heretofore proven less useful for biomedical research areas and/or diagnostics.

### SUMMARY OF THE INVENTION

This invention pertains to the use of paramagnetic endohedral fullerenes as spin labels, MRI contrast agents, bio-reporters, and the like. Since paramagnetic atoms inside a highly symmetric C₆₀ cage can interact with their surroundings only through very weak electronic wave function overlaps or charge transfer, the electron spin resonance relaxation time will be very long and resonance peak will be very sharp and comparable to that of NMR cases. Ideally, the paramagnetic moment should be as isolated as possible from electric fields of neighboring atoms and the magnetic fields of neighboring magnetic moments. This will make ESR endohedral fullerenes spin label a superior technique over NMR. The benefits include, increased sensitivity, decreased instrumentation cost (lower magnetic field required), portability of instrument, increased power to resolve three-dimensional protein structures, multiplexing capability, and the like.

It was a surprising discovery that with the increased relaxation time constants provided by encapsulating certain materials within fullerenes, endohedral fullerenes provide particularly useful spin labels for use in electron spin resonance (ESR) detection systems.

Definitions

The term “fullerene” is used generally herein to refer to any closed cage carbon compound containing both six-and five-member carbon rings independent of size and is intended to include the abundant lower molecular weight C₆₀ and C₇₀ fullerenes, larger known fullerenes including C₇₆, C₇₈, C₈₄, C₉₂, C₁₀₆ and higher molecular weight fullerenes C_{2N} where N is 50 or more (giant fullerenes) that can be nested and/or multi-concentric fullerenes. The term is intended to include “solvent extractable fullerenes” as that term is understood in the art (generally including the lower molecular weight fullerenes that are soluble in toluene or xylene) and to include higher molecular weight fullerenes that cannot be extracted, including giant fullerenes that can be at least as large as C₄₀₀. The term fullerenes additionally include heterofullerenes in which one or more carbons of the fullerene cage are substituted with a non-carbon element (e.g., B, N, etc.) and derivatized/functionalized fullerenes.

Endohedral fullerenes are fullerene cages that encapsulate an atom or atoms in their interior space. They are written with the general formula Mₘ@C₂ₙ, where M is an element, m is the integer 1, 2, 3, 4, 5, or higher, and n is an integer number. The “@” symbol refers to the endohedral or interior nature of the M atom inside of the fullerene cage. Endohedral fullerenes corresponding to most of the empty fullerene cages have been produced and detected under varied conditions. Endohedral metallofullerenes useful for the present invention, include, but are not limited to those where the element M is a lanthanide metal, a transition metal, an alkali metal, an alkaline earth metal, and a radioactive metal.

The terms “derivatization” or “functionalization” generally refer to the chemical modification of a fullerene or the further chemical modification of an already derivatized fullerene. Such chemical modification can involve the attachment, typically via covalent bonds, of one or more chemical groups to the fullerene surface. Further derivatization of a derivatized fullerene refers to further attachment of groups to the fullerene surface.

A “a paramagnetic material caged within a fullerene” refers to a material that when present within an endofullerenes is paramagnetic. The material can be paramagnetic when not caged within the fullerene (e.g., a paramagnetic material) or it can include a material that is not paramagnetic when outside the fullerene, but when caged within the fullerene, the endofullerene is paramagnetic.

The term “nanoparticle”, as used herein refers to a particle having at least one dimension equal to or smaller than about 500 nm, preferably equal to or smaller than about 100 nm, more preferably equal to or smaller than about 50 or 20 nm, or having a crystallite size of about 10 nm or less, as measured from electron microscope images and/or diffraction peak half widths of standard 2-theta x-ray diffraction scans.

The term “specifically binds”, as used herein, when referring to a targeting moiety and its target refers to a binding reaction that is determinative of the presence of the target in a heterogeneous population of molecules (e.g., proteins and other biologics). Thus, under designated conditions (e.g. binding assay conditions in the case of antibody or stringent hybridization conditions in the case of a nucleic acid), the specified targeting moiety preferentially binds to its particular “target” molecule and preferentially does not bind in a significant amount to other molecules present in the sample. In certain embodiments, the terms “specific binding” or “preferential binding” refer to that binding which occurs between such paired species as enzyme/substrate, receptor/agonist, antibody/antigen, and lectin/carbohydrate which may be mediated by covalent and/or non-covalent interactions. When the interaction of the two species typically produces a non-covalently bound complex, the binding which occurs is typically electrostatic, and/or hydrogen-bonding, and/or the result of lipophilic interactions. Accordingly, “specific binding” occurs between pairs of species where there is interaction between the two that produces a bound complex. In particular, the specific binding is characterized by the preferential binding of one member of a pair to a particular species as compared to the binding of that member of the pair to other species within the family of compounds to which that species belongs.

The terms “targeting moiety”, as used herein, refers generally to a molecule that binds to a particular target molecule and forms a bound complex as described above. The binding can be highly specific binding, however, in certain embodiments, the binding of an individual targeting moiety to the target molecule can be with relatively low affinity and/or specificity. The ligand and its corresponding target molecule form a specific binding pair. Examples include, but are not limited to small organic molecules, sugars, lectins, nucleic acids, proteins, antibodies, cytokines, receptor proteins, growth factors, nucleic acid binding proteins and the like which specifically bind desired target molecules, target collections of molecules, target receptors, target cells, and the like.

The term “cancer marker” refers to biomolecules such as proteins that are useful in the diagnosis and prognosis of cancer. As used herein, “cancer markers” include but are not limited to: PSA, human chorionic gonadotropin, alpha-fetoprotein, carcinoembryonic antigen, cancer antigen (CA) 125, CA 15-3, CD20, CDH13, CD 31, CD34, CD105, CD146, D16S422HER-2, phospatidylinositol 3-kinase (PI 3-kinase), trypsin, trypsin-1 complexed with alpha(1)-antitrypsin, estrogen receptor, progesterone receptor, c-erbB-2, bc1-2, S-phase fraction (SPF), p185erbB-2, low-affinity insulin like growth factor-binding protein, urinary tissue factor, vascular endothelial growth factor, epidermal growth factor, epidermal growth factor receptor, apoptosis proteins (p53, Ki67), factor VIII, adhesion proteins (CD-44, sialyl-TN, blood group A, bacterial lacZ, human placental alkaline phosphatase (ALP), alpha-difluoromethylornithine (DFMO), thymidine phosphorylase (dTHdPase), thrombomodulin, laminin receptor, fibronectin, anticyclins, anticyclin A, B, or E, proliferation associated nuclear antigen, lectin UEA-1, cea, 16, and von Willebrand's factor.

The terms “polypeptide”, “peptide” and “protein” are used interchangeably herein to refer to a polymer of amino acid residues. The terms apply to amino acid polymers in which one or more amino acid residue is an artificial chemical analogue of a corresponding naturally occurring amino acid, as well as to naturally occurring amino acid polymers. The term also includes variants on the traditional peptide linkage joining the amino acids making up the polypeptide.

The terms “nucleic acid” or “oligonucleotide” or grammatical equivalents herein refer to at least two nucleotides covalently linked together. A nucleic acid of the present invention is preferably single-stranded or double stranded and will generally contain phosphodiester bonds, although in some cases, as outlined below, nucleic acid analogs are included that may have alternate backbones, comprising, for example, phosphoramide (Beaucage et al. (1993) Tetrahedron 49(10): 1925) and references therein; Letsinger (1970) J. Org. Chem. 35:3800; Sprinzl et al. (1977) Eur. J. Biochem. 81: 579; Letsinger et al. (1986) Nucl. Acids Res. 14: 3487; Sawai et al. (1984) Chem. Lett. 805, Letsinger et al. (1988) J. Am. Chem. Soc. 110: 4470; and Pauwels et al. (1986) Chemica Scripta 26: 1419), phosphorothioate (Mag et al. (1991) Nucleic Acids Res. 19:1437; and U.S. Pat. No. 5,644,048), phosphorodithioate (Briu et al. (1989) J. Am. Chem. Soc. 111:2321, O-methylphophoroamidite linkages (see Eckstein, Oligonucleotides and Analogues: A Practical Approach, Oxford University Press), and peptide nucleic acid backbones and linkages (see Egholm (1992) J. Am. Chem. Soc. 114:1895; Meier et al. (1992) Chem. Int. Ed. Engl. 31: 1008; Nielsen (1993) Nature, 365: 566; Carlsson et al. (1996) Nature 380: 207). Other analog nucleic acids include those with positive backbones (Denpcy et al. (1995) Proc. Natl. Acad. Sci. USA 92: 6097; non-ionic backbones (U.S. Pat. Nos. 5,386,023, 5,637,684, 5,602,240, 5,216,141 and 4,469,863; Angew. (1991) Chem. Intl. Ed. English 30: 423; Letsinger et al. (1988) J. Am. Chem. Soc. 110:4470; Letsinger et al. (1994) Nucleoside & Nucleotide 13:1597; Chapters 2 and 3, ASC Symposium Series 580, “Carbohydrate Modifications in Antisense Research”, Ed. Y. S. Sanghui and P. Dan Cook; Mesmaeker et al. (1994), Bioorganic & Medicinal Chem. Lett. 4: 395; Jeffs et al. (1994) J. Biomolecular NMR 34:17; Tetrahedron Lett. 37:743 (1996)) and non-ribose backbones, including those described in U.S. Pat. Nos. 5,235,033 and 5,034,506, and Chapters 6 and 7, ASC Symposium Series 580, Carbohydrate Modifications in Antisense Research, Ed. Y. S. Sanghui and P. Dan Cook. Nucleic acids containing one or more carbocyclic sugars are also included within the definition of nucleic acids (see Jenkins et al. (1995), Chem. Soc. Rev. pp169-176). Several nucleic acid analogs are described in Rawls, C & E News Jun. 2, 1997 page 35. These modifications of the ribose-phosphate backbone may be done to facilitate the addition of additional moieties such as labels, or to increase the stability and half-life of such molecules in physiological environments.

The term “biotin” refers to biotin and modified biotins or biotin analogues that are capable of binding avidin or various avidin analogues. “Biotin”, can be, inter alia, modified by the addition of one or more addends, usually through its free carboxyl residue. Useful biotin derivatives include, but are not limited to, active esters, amines, hydrazides and thiol groups that are coupled with a complimentary reactive group such as an amine, an acyl or alkyl group, a carbonyl group, an alkyl halide or a Michael-type acceptor on the appended compound or polymer.

Avidin, typically found in egg whites, has a very high binding affinity for biotin, which is a B-complex vitamin (Wilcheck et al. (1988) Anal. Biochem, 171: 1). Streptavidin, derived from Streptomyces avidinii, is similar to avidin, but has lower non-specific tissue binding, and therefore often is used in place of avidin. As used herein “avidin” includes all of its biological forms either in their natural states or in their modified forms. Modified forms of avidin which have been treated to remove the protein's carbohydrate residues (“deglycosylated avidin”), and/or its highly basic charge (“neutral avidin”), for example, also are useful in the invention.

The term “residue” as used herein refers to natural, synthetic, or modified amino acids.

As used herein, an “antibody” refers to a protein consisting of one or more polypeptides substantially encoded by immunoglobulin genes or fragments of immunoglobulin genes. The recognized immunoglobulin genes include the kappa, lambda, alpha, gamma, delta, epsilon and mu constant region genes, as well as myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD and IgE, respectively.

A typical immunoglobulin (antibody) structural unit is known to comprise a tetramer. Each tetramer is composed of two identical pairs of polypeptide chains, each pair having one “light” (about 25 kD) and one “heavy” chain (about 50-70 kD). The N-terminus of each chain defines a variable region of about 100 to 110 or more amino acids primarily responsible for antigen recognition. The terms variable light chain (V_{L}) and variable heavy chain (V_{H}) refer to these light and heavy chains respectively.

Antibodies exist as intact immunoglobulins or as a number of well characterized fragments produced by digestion with various peptidases. Thus, for example, pepsin digests an antibody below the disulfide linkages in the hinge region to produce F(ab)′₂, a dimer of Fab which itself is a light chain joined to V_{H}-C_{H}1 by a disulfide bond. The F(ab)′₂ may be reduced under mild conditions to break the disulfide linkage in the hinge region thereby converting the (Fab′)₂ dimer into a Fab′ monomer. The Fab′ monomer is essentially a Fab with part of the hinge region (see, Fundamental Immunology, W. E. Paul, ed., Raven Press, N.Y. (1993), for a more detailed description of other antibody fragments). While various antibody fragments are defined in terms of the digestion of an intact antibody, one of skill will appreciate that such Fab′ fragments may be synthesized de novo either chemically or by utilizing recombinant DNA methodology. Thus, the term antibody, as used herein also includes antibody fragments either produced by the modification of whole antibodies or synthesized de novo using recombinant DNA methodologies. Preferred antibodies include single chain antibodies (antibodies that exist as a single polypeptide chain), more preferably single chain Fv antibodies (sFv or scFv) in which a variable heavy and a variable light chain are joined together (directly or through a peptide linker) to form a continuous polypeptide. The single chain Fv antibody is a covalently linked V_{H}-V_{L} heterodimer which may be expressed from a nucleic acid including V_{H}- and V_{L}-encoding sequences either joined directly or joined by a peptide-encoding linker. Huston, et al. (1988) Proc. Nat. Acad. Sci. USA, 85: 5879-5883. While the V_{H} and V_{L} are connected to each as a single polypeptide chain, the V_{H} and V_{L} domains associate non-covalently. The first functional antibody molecules to be expressed on the surface of filamentous phage were single-chain Fv's (scFv), however, alternative expression strategies have also been successful. For example Fab molecules can be displayed on phage if one of the chains (heavy or light) is fused to g3 capsid protein and the complementary chain exported to the periplasm as a soluble molecule. The two chains can be encoded on the same or on different replicons; the important point is that the two antibody chains in each Fab molecule assemble post-translationally and the dimer is incorporated into the phage particle via linkage of one of the chains to, e.g., g3p (see, e.g., U.S. Pat. No. 5,733,743). The scFv antibodies and a number of other structures converting the naturally aggregated, but chemically separated light and heavy polypeptide chains from an antibody V region into a molecule that folds into a three dimensional structure substantially similar to the structure of an antigen-binding site are known to those of skill in the art (see e.g., U.S. Pat. Nos. 5,091,513, 5,132,405, and 4,956,778). Particularly preferred antibodies should include all that have been displayed on phage (e.g., scFv, Fv, Fab and disulfide linked Fv (Reiter et al. (1995) Protein Eng. 8: 1323-1331).

The terms “epitope tag” or “affinity tag” are used interchangeably herein, and usually refers to a molecule or domain of a molecule that is specifically recognized by an antibody or other binding partner. The term also refers to the binding partner complex as well. Thus, for example, biotin or a biotin/avidin complex are both regarded as an affinity tag. In addition to epitopes recognized in epitope/antibody interactions, affinity tags also comprise “epitopes” recognized by other binding molecules (e.g. ligands bound by receptors), ligands bound by other ligands to form heterodimers or homodimers, His₆ bound by Ni-NTA, biotin bound by avidin, streptavidin, or anti-biotin antibodies, and the like.

Epitope tags are well known to those of skill in the art. Moreover, antibodies specific to a wide variety of epitope tags are commercially available. These include but are not limited to antibodies against the DYKDDDDK (SEQ ID NO: 1) epitope, c-myc antibodies (available from Sigma, St. Louis), the HNK-1 carbohydrate epitope, the HA epitope, the HSV epitope, the His₄, His₅, and His₆ epitopes that are recognized by the His epitope specific antibodies (see, e.g., Qiagen), and the like. In addition, vectors for epitope tagging proteins are commercially available. Thus, for example, the pCMV-Tag1 vector is an epitope tagging vector designed for gene expression in mammalian cells. A target gene inserted into the pCMV-Tag1 vector can be tagged with the FLAG® epitope (N-terminal, C-terminal or internal tagging), the c-myc epitope (C-terminal) or both the FLAG (N-terminal) and c-myc (C-terminal) epitopes.

A PEG type linker refers to a linker comprising a polyethylene glycol (PEG).

### BRIEF DESCRIPTION OF THE DRAWINGS

FIG. 1 illustrates an instrument set-up used for endohedral fullerene spin resonance detection.

FIGS. 2A and 2B illustrate RF coil and protection circuit design. FIG. 2A: Surface R.F. coil, which is tuned to resonance with the tuning capacitor CT and matched to 50 ohms with a matching capacitor CM. FIG. 2B: Circuit diagram for receiver isolation using a quarter wavelength cable and protection Zener diode.

FIG. 3 illustrates derivatization of an endohedral fullerene spin label resulting in attachment of a targeting moiety.

FIGS. 4A and 4B illustrate labeling of a target (e.g. a cell) using an endohedral fullerene spin label. FIG. 4A illustrates direct labeling of the cell, while FIG. 4B illustrates indirect labeling of the cell.

FIGS. 5A and 5B illustrate generation of the magnetic field gradient. FIG. 5A: The x gradient is formed by a current that runs on a cylinder such that the two arcs above are both bringing current around the cylinder in a clockwise direction. The arcs shown below will bring current around the cylinder in a counter-clockwise direction. This creates a magnetic field pointing in the z direction that varies in strength along the x direction. For a y gradient, this configuration need only be rotated by 90°. FIG. 5B: A magnetic field gradient in the z direction is made by two circular coils whose currents run in opposite directions. This makes a magnetic field that points in the z direction and varies in strength along z.

FIG. 6 illustrates an Evanescent Wave Probe (EWP) set-up used for spin resonance detection.

### DETAILED DESCRIPTION

This invention pertains to the use of paramagnetic endohedral fullerenes as spin labels, MRI contrast agents, bio-reporters, and the like. Since paramagnetic atoms inside a highly symmetric fullerene (e.g., C₆₀) cage have only very weak electron wave function overlaps or charge transfer, the electron spin resonance relaxation time is relatively very long and the electron spin resonance peak is very sharp. In fact, the ESR peak is comparable to that observed in nuclear magnetic resonance (NMR).

Without being bound to a particular theory, it is believed that electron spin resonance (ESR) endohedral fullerene spin labels provide a superior imaging technique over NMR. The benefits include, but are not limited to increased sensitivity, decreased instrumentation cost (lower magnetic field required), improved instrument portability, improved 3-D protein structure determination (any length of protein), the ability to multiplex signals and so forth.

The ESR endohedral fullerene spin labels of this invention comprise a fullerene (e.g., C₆₀, C₇₀, C₈₂, C₈₄, C₉₂, C₁₀₆, etc.) containing an atom that when caged within the fullerene is paramagnetic. Some atoms, such as members Group V of the Periodic table (N, P, As, Sb, or Bi) can in theory contribute a paramagnetic spin by chemically bonding to the carbon wall as an ionized “donor” of an electron into the 1s shell. A similar situation might occur for Group III elements (B, Al, Ga, In, or Tl) acting as ionized “acceptors” to the carbon, creating paramagnetic holes in the 2p shell. Other possibilities, where atomic or ionic radii allow, would include the transition metal series with the magnetic moments of unfilled d shells. These candidates include 3d-series elements Nos. 21 to 29 (Sc, Ti, V, Cr, Mn, Fe, Co, Ni, Cu, and Zn), as well as paramagnetic members of the 4d Nos. 39 to 48 and the 5d series Nos. 71 to 80, all of which can act as a “free” or unbound particle inside the fullerene cage, without constraint by a meaningful chemical bond. Some of the smaller atoms of the Group I alkali metals (Li, Na, K, Rb, or Cs) might also contribute an unpaired electron spin. Members of the lanthanide or “rare earth” series Nos. 57 through 70 with large paramagnetic moments (e,g.,_La, Ce, Pr, Nd, Pm, Sm, Eu, Gd, Tb, Dy, Ho, Er, Tm, or Yb) form unfilled 4f shells can offer the most attractive possibilities from a sensitivity standpoint, provided that their large radii can be accommodated by the fullerene cages. The only elements that are reasonably excluded are the noble gases of Group VIII, which cannot carry a paramagnetic moment.

The endohedral fullerenes comprising the spin labels of this invention can be represented by the formula:
X@Cₙ
where X is the atom caged within the fullerene and Cₙ designates the fullerene (e.g. n can be 60, 70, 82, 84, and so forth).

It has been discovered that, in certain instances, the fullerene compound itself can be used as the active paramagnetic center to relax nearby excited magnetic nuclei. Fullerenes are sometimes referred to as “superatoms,” and in this regard, the arrangement of molecular orbitals on the fullerene can be considered analogous to the atomic orbitals on an atom. If unpaired electrons are associated with the fullerene molecular orbitals, they will create a paramagnetic environment in the same manner as the unpaired d-electrons in Fe³⁺ or the unpaired f-electrons in Gd³⁺. This paramagnetism can then be utilized to relax the spins of nearby excited magnetic nuclei. Hence, the present invention provides fullerenes that include as part of their molecular structure stable molecular radicals or radical ions. In certain embodiments, the endofullerene molecules of the present invention sufficiently water-soluble for in vivo use as ESR spin labels. This can be accomplished for example, by the attachment thereto of various polar groups (e.g. amines, hydroxyl groups, carboxyl groups, and the like).

In certain embodiments, the almost spherical fullerene skeleton (like C₆₀ or C₇₀) can form a Faraday cage for a paramagnetic atom that is implanted inside and there is essentially no charge transfer to the surrounding fullerene. The wave function of the paramagnetic atom is confined within the fullerene, effectively isolated from the environment resulting in a significantly increased relaxation time.

Thus, for example it is noted that a nitrogen atom implanted fullerene produce a paramagnetic center with hyperfine interaction properties very close to that of atomic nitrogen (Almeida Murphy et al. (1996) Phys. Rev. Lett. 77: 1075). The paramagnetic complex is soluble in organic solvents, is stable at room temperature, and withstands exposure to air. The almost spherical fullerene skeleton (like C₆₀ or C₇₀) forms a Faraday cage for the atom that is implanted inside. The paramagnetic atom sits almost exactly at the center, without charge transfer to the cage, the structure of the cage is not distorted and the electronic wave function of the paramagnetic atom is confined within and therefore isolated from the environment. Thus, the relaxation time of this paramagnetic complex is very long (a few hundreds microseconds), which is close to that of NMR specimens.

In certain embodiments, the fullerene is a C₆₀ fullerene. Fullerene C₆₀ is a spherically π-conjugated all carbon molecule that can accept six electrons successively in solution (Hirsch (1994) The Chemistry of the Fullerenes, Thieme, New York; Wie et al. (1992) J. Am. Chem. Soc. 114: 3978). The C₆₀ can be directly attached to carbon, nitrogen, and iridium elements, and the like. Thus the endohedral fullerenes can be directly attached to organic or inorganic molecules at specific position for use as electron spin labels.

In certain embodiments the endohedral fullerenes of this invention can be derivatized to increase solubility and/or serum half-life (e.g., with PEG to increase serum half life in vivo). The endohedral fullerenes can also be functionalized with various inorganic or organic targeting moieties (e.g., lectins, antibodies, nucleic acids, chelates, etc.) in order for them to be delivered to and specifically attached to targeted targeted molecules, cells, tissues, viruses, or pathogens, and the like.

In certain embodiments, targeting moieties are coupled to an epitope tag or chelate. The targeting moiety is administered to the cell, tissue, organ, or organism whereby it localizes at the desired target. Then the endohedral fullerenes attached to the corresponding binding moiety for the epitope tag is administered and localized at the target site(s).

In certain embodiments, the endohedral fullerenes described herein are coupled to one or more targeting moieties so that they specifically or preferentially bind to certain target(s). Generally speaking, materials which can be employed as targeting ligands include, but are not limited to, proteins, including antibodies, glycoproteins and lectins, peptides, polypeptides, saccharides, including mono- and polysaccharides, vitamins, steroids, steroid analogs, hormones, cofactors, bioactive agents, and nucleic acids.

The derivatized endohedral fullerenes can be administered to an organism (e.g., a human and/or non-human mammal) to facilitate ESR detection of one or more target moieties. In various embodiments the derivatized endohedral fullerenes can be used as target-specific detectable labels for use, e.g., in in vitro assays.

The compositions and methods of this invention are particularly well suited for therapeutic/diagnostic applications because they permit visualization, preferably non-invasive visualization of the endohedral fullerene electron spin label(s) and thereby of the cells, tissues, organs, etc. that are tagged by and/or associated with the endohedral fullerene(s). Visualization methods include, but are not limited to X-rays (the endohedral fullerene(s) can act as contrast agents), magnetic resonance imaging (MRI), electron spin resonance imaging, thermographic imaging (e.g., by detecting the signature of the heated nanoparticles), and the like.

In certain particularly preferred embodiments, visualization is by electron spin resonance (ESR). A 3-Dimensional gradient configuration of magnetic field can be easily used to select specific locations. The required magnetic field is much lower (at least ten times) than that required for conventional MRI, making this technology relatively inexpensive (as compared to MRI).

Conventional NMR base MRI imaging can also be performed. In this case, the endohedral fullerene(s) serve as the relaxation T₂ (or T₁) contrast agent. Standard MRI equipment can be used here.

Since the endohedral fullerene spin labels of this invention are paramagnetic, they do not exert magnetic force to each other and form clusters at zero magnetic field (Standley and Vaughan (1969) Electron Spin Relaxatin Phenomena in Solids, Plenum Press). This makes sample preparation and particle delivery very simple. In certain embodiments, the endohedral fullerene(s) can be coated and/or coupled to certain inorganic or organic targeting moieties (e.g. lectins, antibodies, nucleic acids, chelates, etc.) in order for them to be delivered and attached to the target (e.g., protein, sugar, diseased cell tissue or organ, viruses or pathogens, etc.). In certain embodiments, targeting moieties are coupled to an epitope tag or chelate. The targeting moiety is administered to the cell, tissue, organ, or organism whereby it localizes at the desired target. Then the endohedral fullerene(s) attached to the corresponding binding moiety for the epitope tag is administered. The endohedral fullerene(s) associate with the bound targeting moietie(s) thereby specifically/preferentially localizing the spin label at the target site(s).

I. Preparation and Derivatization of Endohedral Fullerenes.

A) Endohedral Fullerene Preparation.

Endohedral fullerenes can be produced by any of a number of methods known to those of skill in the art. One approach utilizes an arc burning apparatus that accommodates several pairs of carbon rods. The carbon rods can be doped with the species it is desired to incorporate into the endohedral fullerene. Thus, for example, trimetallic-nitride-containing fullerenes such as HO₃N@C₈₀, can be created using holmium-containing graphite rods and additional nitrogen compounds, and/or even using reactive gases in the atmosphere of the arc burning chamber to fine-tune the synthetic process. By adjusting the reaction conditions in the arc chamber, it's possible to get an endohedral structure like Ho₃N@C₈₀ as a main product.

Metallofullerenes are made by a variety of known methods, see, e.g., Dorn et al. (1999) Chemical and Engineering News, September. 20, page 54). Typically, metallofullerenes are produced by the Krätschmer arc burning method and isolated by multistep HPLC separation techniques.

Noble gases are also readily encapsulated inside fullerenes. Thus, for example, helium, neon, argon, krypton, and xenon have been placed into fullerenes by heating the fullerene in the presence of the gas at 650° C. and 3,000 atm. HPLC is used to separate the endofullerenes from the empty fullerenes (see, e.g., (2002) J. Am. Chem. Soc., 124: 62216).

In other embodiments, endohedral fullerenes are synthesized using a plasma chemical reactor (see, e.g., Churilov et al. (1999) Carbon, 37: 427; Churilov (2000) Instruments and Experimental Techniques, 43(1:1. Translated from Pribory i Tekhnika Eksperimenta, 1, 5 (2000)). This reactor has the ability to introduce substances into a carbon plasma jet.

Similarly, various laser ablation methods are also utilized for the production of endohedral fullerenes. Such methods have been used to synthesize nitrogen-containing endohedral fullerenes (see, e.g., Ying (1996) J. Phys. B: At. Mol. Opt. Phys. 29(21): 4935-4942; Almeida Murphy et al. (1996) Spaeth, Phys. Rev. Lett. 77, 1075, and the references cited therein).

Typically the endohedral fullerenes are purified to separate the endohedral fullerenes (fullerenes containing the desired moiety) from empty fullerenes. Often this is accomplished by HPLC, but other methods are also known to those of skill in the art. In this regard it is noted that U.S. Patent Publication 2003/0157016 describes a purification method based on selective formation of cationic fullerene species by chemical protonation or addition of other cationic electrophilic groups, which is distinct from fullerene cation formation via the chemical or electrochemical oxidation. Cation formation can equally be conducted by oxidative electrochemistry or by chemical addition of a cationic agent, such as protonation by a Bronsted acid or addition of an electrophile. Photochemical cation generation methods can also be used.

The production of metallofullerene M@C₆₀ class materials is described in U.S. Patent Publication 2003/0065206), and PCT application PCT/US02/31362.

B) Functionalization/Derivatization of Endohedral Fullerenes.

In various embodiments the endohedral fullerenes of this invention can be functionalized to accomplish one of more a number of goals. In certain embodiments the fullerenes are derivatized to prevent aggregation. Aggregation of fullerenes used in in vivo applications is undesirable because it can lead to recognition and uptake of the aggregated fullerene particles by the reticuloendoplasmic system (RES) which can lead to an undesirable biodistribution of the fullerene in tissues, such as the liver, and which results in undesired retention of the fullerenes in the organism.

In various embodiments, the endofullerenes are derivatized to increase serum half-life (e.g. to prevent scavenging, chelating, hydrolysis, cellular uptake, immune response, and/or uptake by the RES). Thus, in certain embodiments the endofullerenes are derivatized with polyethylene glycol (PEG) to increase serum half-life. Methods of pegylating organic molecules are well known to those of skill in the art.

In certain embodiments the endofullerenes are derivatized, e.g., with polar groups such as amino, hydroxyl, carboxyl, and the like to improve solubility in water.

The endofullerenes can also be derivatized to provide convenient functional groups for the direct attachment of a targeting moiety or the attachment of a linker as described herein.

Methods of derivatizing/functionalizing endofullerenes are known to those of skill in the art.

Various procedures, methods and techniques known in the art for introducing functional groups onto the fullerene cage of fullerenes or metallofullerenes can be utilized. Reviews of fullerene chemistry including methods for derivatization of fullerenes and metallo fullerenes are described by Hirsch (1994) The Chemistry of the Fullerenes, Georg Thieme Verlag Stuttgart, New York, Wilson et al. (2000) Organic Chemistry of Fullerenes, Pp. 91-176 In: Fullerenes: Chemistry, Physics, and Technology, Kadish, K. M. and Ruoff, R. S. eds., John Wiley & Sons, New York, U.S. Pat. Nos. 6,162,926 and 6,399,785 and the references therein, and the like.

Methods that can be applied to fullerene cage derivatization useful in the present invention include, but are not limited to, cycloadditions, Diels-Alder [4+2] cycloadditions, [3+2] cycloadditions, oxidative [3+2] cycloadditions. addition of azides, addition of diazomethanes, diazoacetates, diazoamides, addition of trimethylenemethanes, addition of nitrile oxidesaddition of sulfinimides, addition of disiliranes, addition of azomethine ylides (fulleropyrrolidine and fulleroproline formation, including the so-called “Prato reaction” conditions), [2+2] cycloadditions (photochemical and otherwise), [2+1] cycloadditions (addition of carbenes and silylenes), halogenation, arylation, halogenation, followed by substitution or partial substitution, nucleophilic additions, Michael additions, the Bingel-Hirsch reaction, modified Bingel addition (see, e.g., Published U.S. Patent Application No: 20030065206 A1), addition of amines, direct addition of nucleophiles (anionic and neutral nucleophiles) (e.g., carbanions, alkoxides, metal-organic intermediates, etc.), electrophilic addition, radical addition (e.g., mono- and poly-radical addition), addition/coordination of organometallic and/or metal coordination complexes, and the like.

Methods for performing such derivatizations are illustrated in U.S. Patent Publication 2003/0220518. The derivatization methods described therein are based, in one embodiment, on the cyclopropanation reaction as applied to soluble fullerenes (U.S. Pat. No. 5,739,376) and as applied to insoluble fullerenes as described in U.S. Patent Publication 2003/0065206. Base-induced deprotonation of α-halo (halogen: F, Cl, Br, I) substituted bis-malonates and more generally alpha-halo-CH-acids (see U.S. Pat. No. 5,739,376) produces an incipient carbanion. This nucleophilic carbanion adds to the fullerene surface, making a new carbon-carbon bond, followed by elimination of the halide anion, completing the cyclopropanation and leaving a neutral derivative group positioned 1,2 across a carbon-carbon double bond of the fullerene. The cyclopropanation reagent can also be generated in situ by treatment of mono- and bis-malonates and other acids and esters, for example, with halogen-releasing agents such as CBr₄I₂, etc. This allows for derivatization with more elaborately substituted groups for which the α-halo precursor may be difficult to individually prepare and/or isolate as a reagent.

Other method for functionalizing the fullerene cage, e.g., so that it can be safely employed in vivo for electron spin resonance detection include, but are not limited to:

Chemical derivatization that produces a radical fullerene core as part of the reaction sequence. One such example is a reaction that uses sequential addition of OH⁻ to produce a C₆₀(OH)₃₂¹⁻ anion is one such example.

Another approach involves electrochemical oxidation or reduction. For example, certain endofullerene comounds can be electrochemically reduced or oxidized, e.g., to form a paramagnetic radical. Similarly, reduction of an endohedral fullerene fullerene compound can be accomplished with any sufficiently strong reducing or oxidizing agent. In certain instances, the oxidizing or reducing agent can be incorporated within the fullerene. For example, in certain instances, an encapsulated metal such as an alkali metal, alkaline earth metal, or lanthanide metal with a redox potential sufficient to reduce the fullerene cage and and thereby form certain reactive sites can be placed in the cage. In certain instances, an oxidizing or reducing agent can be linked to the fullerene shell. For example, a tertiary nitrogen group can be attached to the fullerene forming a charge transfer complex in which the radical electron is located on the fullerene shell.

In certain embodiments, the shell of the fullerene can be doped to achieve a radical electronic configuration. For example, an N atom may be incorporated into the fullerene shell to produce a radical such as such as C₅₉N and thereby provide a reactive site, e.g, for attachment of a linker.

The endohedral fullerene and/or its derivatives may or may not be ionic, depending upon how the complex is designed. Some compounds, such as C₆₀(OH)₃₂¹⁻ are ionic, but other compounds may be built so that they are internally charge compensated such as K⁺@C₆₀(OH)₃₂¹⁻ or other types of zwitterionic configurations. If the compound is ionic, then it is water soluble and can easily be administered with an appropriate biologically safe counterion such as glucamine⁺, Na⁺, Cl⁻, and the like.

In order to operate effectively within a living body, the endohedral fullerene spin label is preferably rendered water-soluble, e.g., by an appropriate derivation process. This can be performed by derivatizing the fullerene shell with functional groups to impart water solubility and/or attaching the fullerene shell to a larger water-soluble molecule. The choice of functionalization method also alter and control the biodistribution of the label, elimination pathways, and possible toxicity of the label.

Several reactions for making fullerenes water soluble are described by Hirsch (1994) supra. and can also be found in U.S. Pat. No. 6,355,225. Suitable methods include but are not limited to attachment of multiple hydroxyl groups, e.g., as described by Chiang et al. (1992) J. Chem. Soc. Chem. Commun., pp 1791, Zhang et al. (2004) Chinese J. Chem., 22: 1008-1011, and the like. Fullerenes can also be polyhydroxylated using the methods described in U.S. Pat. No. 5,177,248. Polyhydroxylated fullerenes can be further derivatized using the —OH groups to form new functional groups such as esters, for example. Carboxylic acid groups can be conveniently attached using, e.g., the Bingle-Hirsch reaction to add malonic acid groups to a fullerene (reviewed by Hirsch 1994, supra). Other methods of adding carboxylic acid groups have been reported (Isaacs and Diederich (1993) Helv. Chim., 76: 2454). The carboxylic acid provides a convenient method (through an amide linkage) to attach the fullerene to other water-solubilizing functional groups. Addition of multiple amines is described by Hirsch et al. 1994, supra., while increasing solubility by attachment of amino acids is taught by Skiebe and Hirsch (1993) Chem. Ber., 126: 1061, and Yang and Barron (2004) Chem. Commun., 24: 2884-2885. It is also noted that the addition of multiple alkyl sulfonates has been used to produce a water-soluble fullerene Chen et al. (1998) ______. The fullerene can be attached to water-soluble polymers such as PEG (polyethylene glycol), (Tabata et al. (1997) Jp. J. Cancer Res., 88(11): 1108-1116). The endohedral fullerene can also be built into water-soluble dendrimers and the like. (reviewed by Hirsch 1994, supra). Similarly methods of iodinating fullerenes are also know to those of skill in the art (see, e.g., U.S. Pat. No. 6,660,248).

It is noted that the foregoing derivatizations are illustrative and note intended to be limiting. It is contemplated that other groups, including but not limited to alkyl and aliphatic groups, can be included on or in the present endofullerene spin labels without departing from the scope of the present invention.

It will be appreciated by those in the art that it may not be possible, due to steric constraints, the type of reaction being employed, or changes in reactivity with increasing functionalization, to derivatize all available sites on the fullerene cage. The maximum number of functional groups that can be attached to a given fullerene cage will depend upon the size of the fullerene cage as well as upon the size and chemical nature of the functional group or groups that are to be attached and in most cases will be less than the number of available sites for derivatization. In general, it is possible to attached a larger number of sterically smaller functional groups to a given fullerene cage than sterically larger functional groups. It will further be recognized that due in general to the large number of possible derivatization sites on a fullerene a mixture of derivatives which may contain different numbers of functional groups or different isomers is most often generated during reactions.

Methods are available in the art for enhancing the amount of a desired fullerene derivative in a mixture, in particular derivatives exhibiting differential solubility properties can often be separated. However, application of such methods may not be needed to achieve the desired beneficial effect of derivatization. Often a mixture of derivatives can be employed without significant detrimental effect.

It will be appreciated by those in the art that multiple functional groups can be attached to a fullerene cage in a single reaction and that the number of groups attached can generally be controlled by adjusting the reaction conditions employed. When it is desired to derivatized a fullerene with two or more different non-hydrogen functional groups, the order in which the derivation reactions are carried out may affect the outcome of the reactions.

C) Targeting Moieties for Attachment to Endohedral Fullerenes.

In certain embodiments, the endohedral fullerene spin labels described herein are coupled to one or more targeting moieties so that they specifically or preferentially bind to certain target(s) (e.g. cancer cells). Generally speaking, materials that can be employed as targeting ligands include, but are not limited to, proteins, including antibodies, glycoproteins and lectins, peptides, polypeptides, saccharides, including mono- and polysaccharides, vitamins, steroids, steroid analogs, hormones, cofactors, bioactive agents, and genetic material, including nucleosides, nucleotides and polynucleotides.

The targeting moieties that may be incorporated in the compositions of the present invention are preferably substances that are capable of targeting (e.g. specifically or preferentially binding) receptors, and/or particular cell-surface markers, and/or particular cells, and/or particular organs or tissues in vivo.

With respect to the targeting of cancers (e.g., solid tumors or cancer cells), it is noted that a number of cancer-specific markers are known to those of skill in the art. Such markers include, but are not limited to C-myc, p53, Ki67, erbB-2, Her2, Her4, BRCA1, BRCA2, Lewis Y, CA 15-3, G250, HLA-DR cell surface antigen, CEA, CD2, CD3, CD7, CD19, CD20, CD22, integrin, EGFr, AR, PSA, carcinoembryonic antigen (CEA), the L6 cell surface antigen (see, e.g., Tuscano et al. (2003) Neoplasia, 3641-3647; Howell et al. (1995) Int J Biol Markers 10:126-135; Marken et al. (1992) Proc. Natl. Acad. Sci. U.S.A. 89: 3503-3507, 1992), growth factor receptors, and/or various intracellular targets (e.g. receptors, nucleic acids, phosphokinases, etc.) and the like.

In certain embodiments, targeting moieties can be selected for targeting antigens associated with breast cancer, such as epidermal growth factor receptor (EGFR), fibroblast growth factor receptor, erbB2/HER-2 and tumor associated carbohydrate antigens (Siegall (1994) Cancer, 74(3): 1006-12). CTA 16.88, homologous to cytokeratins 8, 18 and 19, is expressed by most epithelial-derived tumors, including carcinomas of the colon, pancreas, breast, ovary and lung. Thus, antibodies directed to these cytokeratins, such as 16.88 (IgM) and 88BV59 (IgG3k), that recognize different epitopes on CTA 16.88 (Jager et al. (1993) Semin. Nucl. Med., 23(2): 165-79), can be employed as targeting ligands. For targeting colon cancer, anti-CEA antibodies, e.g., IgG Fab′ fragments may be employed as targeting ligands. In certain embodiments, chemically conjugated bispecific anti-cell surface antigen, anti-hapten Fab′-Fab antibodies can also be used as targeting moieties. The MG series monoclonal antibodies can be selected for targeting, for example, gastric cancer.

There are a variety of cell surface epitopes on epithelial cells for which targeting ligands may be selected. For example, the protein human papilloma virus (HPV) has been associated with benign and malignant epithelial proliferations in skin and mucosa. Two HPV oncogenc proteins, E6 and E7, may be targeted as these may be expressed in certain epithelial derived cancers, such as cervical carcinoma (see, e.g., (1994) Curr. Opin. Immunol., 6(5): 746-754). Membrane receptors for peptide growth factors (PGF-R), which are involved in cancer cell proliferation, cam also be selected as tumor antigens (see, e.g, (1994) Anticancer Drugs, 5(4): 379-393). Also, epidermal growth factor (EGF) and interleukin-2 may be targeted with suitable targeting ligands, including peptides, which bind these receptors. Certain melanoma associated antigens (MAA), such as epidermal growth factor receptor (EGFR) and adhesion molecules (Merimsyk et al. (1994) Tumor Biol., 15(4): 188-202), that are expressed by malignant melanoma cells, can be targeted with the compositions provided herein. The tumor associated antigen FAB-72 on the surface of carcinoma cells can may also be selected as a target. These targets are intended to be illustrative and not limiting.

In certain embodiments, an example of a protein that may be preferred for use as a targeting ligand is Protein A, which is protein that is produced by most strains of Staphylococcus aureus. Protein A is commercially available, for example, from Sigma Chemical Co. (St. Louis, Mo.). Protein A can then be used for binding/targeting a variety of IgG antibodies. Generally speaking, peptides which are particularly useful as targeting ligands include natural, modified natural, or synthetic peptides that incorporate additional modes of resistance to degradation by vascularly circulating esterases, amidases, or peptidases. One very useful method of stabilization of peptide moieties incorporates the use of cyclization techniques. As an example, the end-to-end cyclization whereby the carboxy terminus is covalently linked to the amine terminus via an amide bond can be useful to inhibit peptide degradation and increase circulating half-life. Additionally, a side chain-to-side chain cyclization is also particularly useful in inducing stability. An end-to-side chain cyclization can be a useful modification as well. In addition, the substitution of one or more L-amino acid(s) with D-amino acid(s) can offer resistance to biological degradation. Suitable targeting ligands, and methods for their preparation, will be readily apparent to one skilled in the art, once armed with the disclosure herein.

D) Attaching the Targeting Moiety to the Endohedral Fullerene Spin Label.

In one embodiment, the targeting molecule (e.g., a HER2 antibody, an anti Le^{Y} antibody, etc.) is chemically conjugated to the endohedral fullerene. Means of chemically conjugating molecules are well known to those of skill. In certain embodiments, multiple targeting moieties are joined to each endohedral fullerene. In certain embodiments, multiple endohedral fullerenes are attached to each targeting moiety, and in other embodiments, one targeting moiety is attached to endohedral fullerene. The attachment can be direct or through a linker.

The procedure for attaching an endohedral fullerene to an antibody or other targeting moiety will vary according to the chemical structure of the targeting moiety and/or the functionalization of the endohedral fullerene. Polypeptides, for example, typically contain a variety of functional groups; e.g., carboxylic acid (COOH) groups, hydroxyl groups, free amine (—NH₂) groups, and the like, that are available for reaction with a suitable functional group on, e.g. a derivatized endohedral fullerene and/or linker to bind the targeting moiety thereto.

In certain embodiments, the targeting moiety and/or the endohedral fullerene(s) can be derivatized to expose or attach additional reactive functional groups. The derivatization may involve attachment of any of a number of linker molecules such as silanes, crosslinking reagents such as gluteraldehyde, and the like. Such reagents are available from any of a number of suppliers, e.g., Pierce Chemical Company, Rockford Ill.

A “linker”, as used herein, is a molecule that can be used to join the targeting moiety to the endohedral fullerene(s). The linker is capable of forming covalent bonds to both the targeting moiety and to the typically derivatized endohedral fullerene(s). Suitable linkers are well known to those of skill in the art and include, but are not limited to, straight or branched-chain carbon linkers, heterocyclic carbon linkers, peptide linkers, and the like. Where the targeting moiety comprises a polypeptide, the linker can be joined to the constituent amino acids through their side groups (e.g., through a disulfide linkage to cysteine), and/or to the alpha carbon amino, and/or carboxyl groups of the terminal amino acids.

A bifunctional linker having one functional group reactive with a group on the endohedral fullerene(s), and another group reactive with, for example, an antibody, may be used to form the desired immunoconjugate. Alternatively, derivatization can involve chemical treatment of the targeting moiety, e.g., glycol cleavage of the sugar moiety of a glycoprotein antibody with periodate to generate free aldehyde groups. The free aldehyde groups on the antibody may be reacted with free amine or hydrazine groups on a linker or endohedral fullerene to bind the endohedral fullerene(s) thereto (see, e.g., U.S. Pat. No. 4,671,958). Procedures for generation of free sulfhydryl groups on polypeptides, such as antibodies or antibody fragments, are also known (see, e.g., U.S. Pat. No. 4,659,839).

It is noted that the attachment of a fullerene cage to a polypeptide is described by Toniolo et al. (1994) J. Med. Chem., 26: 4588-4562).

In addition, antibodies have been generated that specifically bind to fullerenes (see, e.g., Braden et al. (2000) Proc. Natl. Acad. Sci. USA, 97(22): 12193-12197; Noon et al. (2002) Proc. Natl. Acad. Sci. USA, 99(2): 6466-6470). These antibodies can be derivatized with one or more targeting moieties and then used to conjugate the targeting moieties to the endohedral fullerene.

Many procedure and linker molecules for attachment of various compounds including radionuclide metal chelates, toxins and drugs to proteins such as antibodies are known (see, e.g., European Patent Application No. 188,256; U.S. Pat. Nos. 4,671,958, 4,659,839, 4,414,148, 4,699,784; 4,680,338; 4,569,789; and 4,589,071; and Borlinghaus et al. (1987) Cancer Res. 47: 4071-4075) and can be used in the present context. In particular, production of various immunoconjugates is well-known within the art and can be found, for example in “Monoclonal Antibody-Toxin Conjugates: Aiming the Magic Bullet,” Thorpe et al., Monoclonal Antibodies in Clinical Medicine, Academic Press, pp. 168-190 (1982), Waldmann (1991) Science, 252: 1657, U.S. Pat. Nos. 4,545,985 and 4,894,443, ante the like.

In some circumstances, it is desirable to free the endohedral fullerene(s) from the targeting moiety when conjugate has reached its target site. Therefore, targeting moiety/endohedral fullerene conjugates comprising linkages that are cleavable in the vicinity of the target site can be used when the endohedral fullerene(s) are to be released at the target site. Cleaving of the linkage to release the endohedral fullerene(s) from the targeting moiety can be prompted by enzymatic activity or conditions to which the conjugate is subjected either inside the target cell or in the vicinity of the target site. When the target site is a tumor, a linker which is cleavable under conditions present at the tumor site (e.g., when exposed to tumor-associated enzymes or acidic pH) may be used.

A number of different cleavable linkers are known to those of skill in the art. See U.S. Pat. Nos. 4,618,492; 4,542,225, and 4,625,014. The mechanisms for release of an agent from these linker groups include, for example, irradiation of a photolabile bond and acid-catalyzed hydrolysis. U.S. Pat. No. 4,671,958, for example, includes a description of immunoconjugates comprising linkers that are cleaved at the target site in vivo by the proteolytic enzymes of the patient's complement system. In view of the large number of methods that have been reported for attaching a variety of radiodiagnostic compounds, radiotherapeutic compounds, drugs, toxins, and other agents to antibodies and other targeting moieties, one skilled in the art will be able to determine a suitable method for attaching a given targeting moiety to the endohedral fullerene(s) of interest.

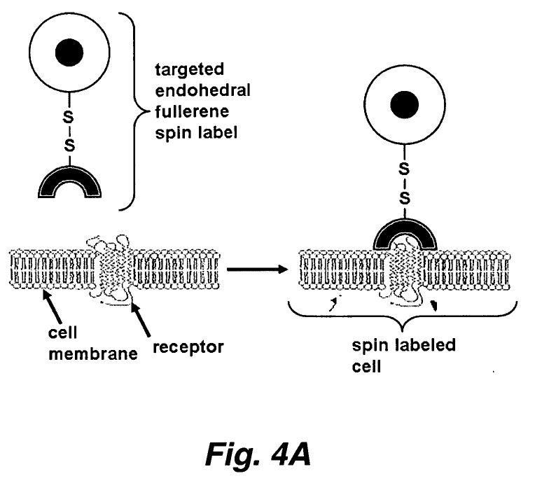

In certain particularly preferred embodiments the endohedral fullerene(s) are attached to targeting moieties (e.g., to antibodies or other high-affinity ligands) by coating/derivatizing the particles with one or more organic molecules (e.g, sulfhydryl) to produce derivatized/functionalized endohedral fullerene (see, e.g., FIG. 3A). The functionalized endohedral fullerene(s) are then reacted, e.g. with appropriately derivatized targeting moieties to covalently couple the fullerene to one or more targeting moieties (see, e.g., FIG. 3A).

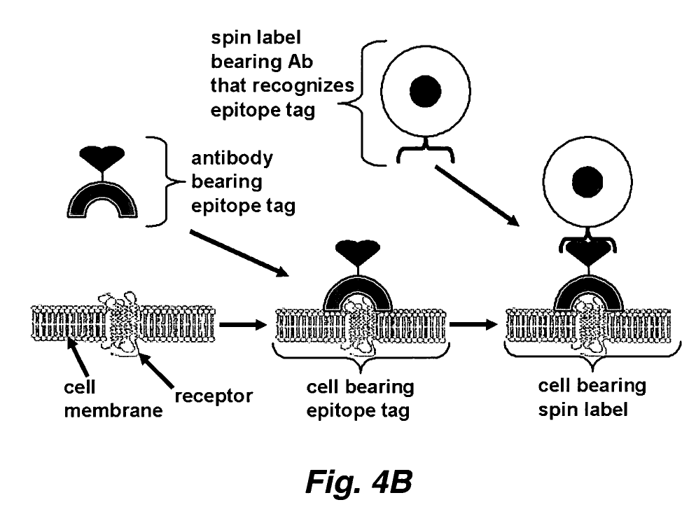

The endohedral fullerene bearing spin label bearing the targeting moieties can then specifically bind to and thereby label its cognate target, e.g. the surface of a cell (see, e.g., FIG. 4A) and the labeled target (e.g., cell) can then be imaged using electron spin resonance.

In certain preferred embodiments, the endohedral fullerene(s) are joined to an antibody or to an epitope tag, e.g., through a chelate. The targeting moiety bears a corresponding epitope tag or antibody so that simple contacting of the targeting moiety to the endohedral fullerene(s) results in attachment of the targeting moiety with the endohedral fullerene(s) (see, e.g., FIG. 4B). The combining step can be performed before the targeting moiety is used (targeting strategy) or the target tissue can be bound to the targeting moiety before the endohedral fullerene chelate is delivered. Methods of producing chelates suitable for coupling to various targeting moieties are well known to those of skill in the art (see, e.g., U.S. Pat. Nos. 6,190,923, 6,187,285, 6,183,721, 6,177,562, 6,159,445, 6,153,775, 6,149,890, 6,143,276, 6,143,274, 6,139,819, 6,132,764, 6,123,923, 6,123,921, 6,120,768, 6,120,751, 6,117,412, 6,106,866, 6,096,290, 6,093,382, 6,090,800, 6,090,408, 6,088,613, 6,077,499, 6,075,010, 6,071,494, 6,071,490, 6,060,040, 6,056,939, 6,051,207, 6,048,979, 6,045,821, 6,045,775, 6,030,840, 6,028,066, 6,022,966, 6,022,523, 6,022,522, 6,017,522, 6,015,897, 6,010,682, 6,010,681, 6,004,533, 6,001,329, and the like).

II. Spin Resonance Line Width.

The spin resonance line width is inversely proportional to the lifetime of the spin energy level. For the purpose of selective excitation of the magnetic resonance and high spatial resolution in imaging, the frequency bandwidth is desirably narrow.

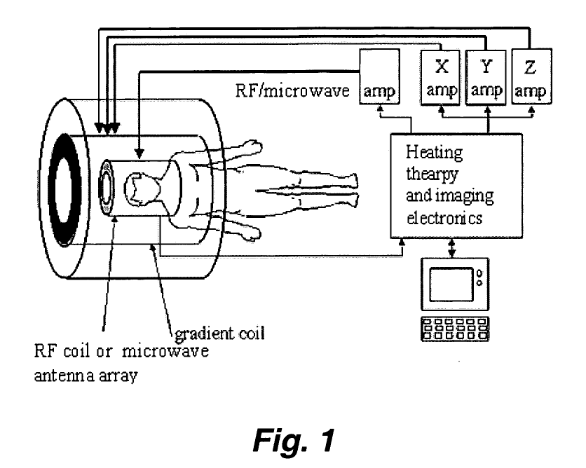

The line width of the spin resonance can readily be detected using simple modifications to the set up shown in FIG. 1. To avoid absorption by water or biological fluids in the microwave region, the microwave frequency should be as low as possible since water absorption increase with the microwave frequency. On the other hand the heating rate of magnetic resonance drops at lower frequency. In certain embodiments, the optimized frequency should be in the range of about 50 to about 2000 MHz, preferably about 100 to about 1000 MHz, more preferably from about 500 to about 1000 MHz. In this frequency range an RF coil can be used as an RF transmitter and receiver. Compared to the resonator detector shown in FIG. 1, the RF coil may have a higher RF power transfer efficiency and can achieve uniform RF distribution in relatively larger regions. It also provides an open environment that is convenient to characterize the heating efficiency. Phase array antenna can be used for radiation and detection of RF wave.

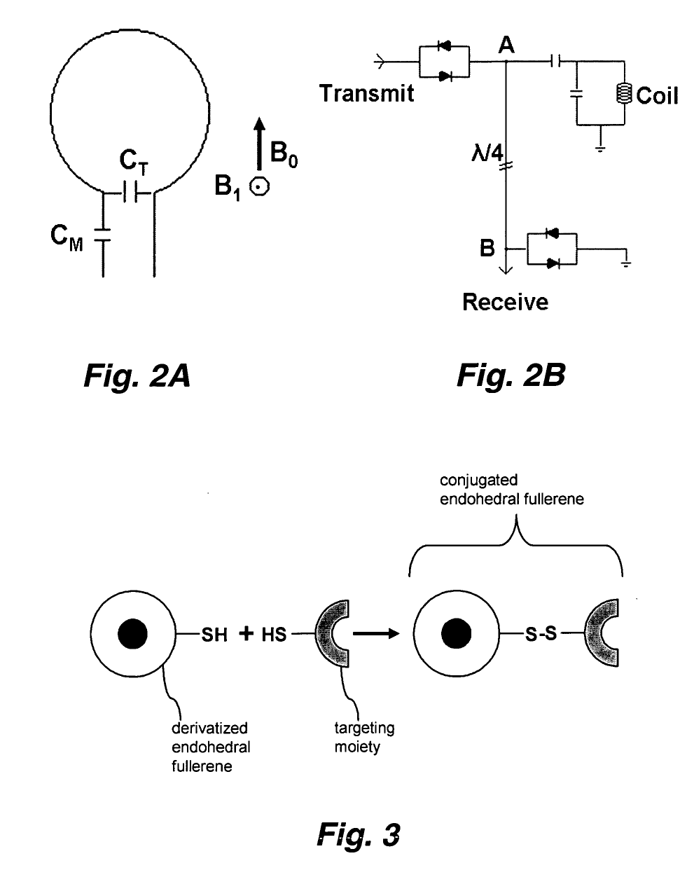

A surface coil can be applied to small volumes for sample detection. In its simplest form it is a coil of wire coupled with a capacitor in parallel. The inductance of the coil, and the capacitance form a resonant circuit, which is tuned to have the same resonant frequency as the spins to be detected. A second capacitor can be added in series with the coil, as shown in FIG. 2A, to match the coil impedance to, e.g., 50Ω. To prevent excitation pulse saturation or break-down of the receiver electronics which are designed to detect signals up to 6 orders lower than the input power, a simple protection circuit can be used as shown in FIG. 2B. To achieve a better signal noise ratio, the pulse RF signal can be used to replace the CW microwave signal. T his can be realized with the same microwave synthesizer by simply adding the pulse modulation control.

The importance of narrow resonance line width for high near-resonance sensitivity is seen in both the real and imaginary parts of the complex permeability μ=μ′+iμ″. In microwave (RF) circuits, μ′ controls the signal phase and μ″ controls the energy absorption or circuit Q factor. Their relations as a function of angular frequency ω can be expressed as:

$$\begin{matrix}\begin{matrix}{μ}^{′} = 1 + \frac{γ4π M ( ω - {ω}_{0} )}{( {ω}^{2} - {ω}_{0}^{2} ) + {{γ}^{2} ( Δ H )}^{2}} \\ \approx 1 + \frac{γ4π M ( ω - {ω}_{0} )}{{{γ}^{2} ( Δ H )}^{2}} ( near resonance )\end{matrix} \\ and & 3 A \\ \begin{matrix}{μ}^{″} = 1 + \frac{γ4π M γ ( Δ H )}{( {ω}^{2} - {ω}_{0}^{2} ) + {{γ}^{2} ( Δ H )}^{2}} \\ \approx \frac{4 π M}{Δ H} ( at resonance ) ,\end{matrix} & 3 B\end{matrix}$$

where 4πM is the magnetization comprising the volume density of individual magnetic moments m, ω₀ is the resonance frequency, and ΔH is the line width. The factor γ is the gyromagnetic constant and is derived from the Larmor precession relation between frequency and field, given by:

$${ω}_{0} = γ H = \frac{g \vert e \vert}{2 mc} H , \qquad ( 4 )$$

where e is the electron or proton charge, m is the particle mass and c is the velocity of light, and g (˜2 for spins) is the spectroscopic splitting factor. Note that e is the same magnitude for both protons and electrons, but mₙ for protons is greater than mₑ for electrons by a factor 1836, thereby reducing the resonance frequency by a factor of more than 10³ for a given magnetic field intensity H.

From equation 3B, the imaginary part of susceptibility μ″ is proportional to 1/ΔH (ΔH is line width), and μ″ is directly related to the RF energy absorption of the material, which means that materials with narrow spin resonance line width will have high RF absorption efficiency.

In certain embodiments, the RF will range from about 400 MHz to about 1 GHz. In this context, a typical/reasonable pulse width is about 1 μs, which corresponds to a line width of 1 MHz and quality factor of about 500˜1000. If the line width of selected material is too broad (low quality factor), the absorption band of the material will not be covered effectively by the RF pulse spectrum. Thus the spin resonance quality factor of the selected material should be larger than 10, more preferably larger than about 50, still more preferably larger than about 100, 200, or 500. In certain embodiments, the spin resonance quality factor (Q) ranges from these values up to about 800, 1000, 15000, 2000, or 3000. In certain embodiments, the Q factor ranges from about 100 to about 1000.

Several factors contribute to the line width, chief among which are (1) spin-lattice interactions of individual spins, characterized by a relaxation time T₁, and (2) incoherent precession phasing of spins, characterized by a relaxation time T₂ that arises from misaligned spins coupled by dipolar interactions. Precession phase decoherence can also occur in exchange ordered electron spin systems by spin wave generation, particularly in higher power cases where imperfections or non-uniform RF fields exist in a specimen having dimensions greater than the wavelength of the RF signal. These mechanisms are generally considered to be homogeneous and produce a Lorentzian line shape.

III. Instrument Set-Up for ESR Detection of Endohedral Fullerene Spin Labels.

FIG. 1 illustrates an instrument set-up used for characterization of particle spin resonance detection. The setup is similar to the conventional MRI setup. Driven by the control electronics through X, Y, Z amplifier, the gradient coil can provide a gradient magnetic field variable in three dimensions (X, Y, and Z) which permits localization of signal detection to the specific desired region of tested sample or organism (e.g., human body). The RF coil or alternatively the microwave antenna array is used as a spin resonance detection element. The gradient field can be applied so that only the section contains the interesting region is imaged.

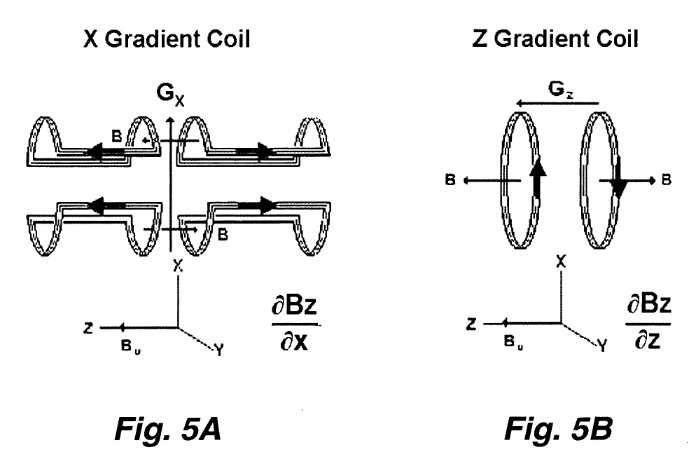

In certain embodiments utilizing larger specimens (e.g., organisms), the surface coil is preferably replaced with a commercial available “birdcage” coil, which can provide uniform RF distribution over a larger volume. To realize localized/spatially resolved imaging, a magnetic field gradient is provided. FIGS. 5A and 5B illustrate the generation of gradient field for three-dimensional imaging.

Magnetic field gradients are spatially dependent variations in the magnetic field created by electrical DC currents in specifically designed coil arrangements. For example, a linear magnetic field gradient that varies spatially along the z direction of the main magnet can be produced using a Maxwell pair of coils as pictured in FIG. 5B. Such a magnetic field, when applied to a sample of homogeneous material like water, causes the spins on one side of the sample with respect to the z direction to have a different frequency from spins on the other side of the sample. A distribution of frequencies will be obtained along the sample. The amount of magnetization at each frequency will be the integral of the signal along a surface perpendicular to the applied field gradient. An x gradient is obtained using, for example, a coil configuration as shown in FIG. 5A, and need only be rotated by 90 degrees to obtain any gradient. Both of these make fields that add or subtract from the main magnetic field pointing along z but the magnetic field strength varies in the x or y direction.

The three-dimensional imaging setup preferably controls the gradient field and RF pulse in a specific time sequence. Software controlling the device can offer the following functions: 1) Control of the gradient field to realize the planar selection for heating and magnetic resonance detection; 2) Control of the RF pulse sequence according to the desired application. In certain embodiments, a continuous 180° pulse is provided with period related to the relaxation time of the magnetic resonance. Typically, for imaging, however, a 90° pulse is provided to observe the relaxation signal. 3) FFT or other functions can be used to analyze the line width of the spin resonance (Ernst et al. (1987) Principles of Nuclear Magnetic Resonance in One and Two Dimensions, Clarendon Press Oxford) and reconstruct the image when phase encoding and frequency encoding pulse is used to realize the image.

In addition to the gradient field technique, there are also some other spatially resolved ESR detection technologies which can be used to detect spin labels, such as the proprietary Evanescent Microwave Probe (EWP) technology invented by Internatix Corporation.

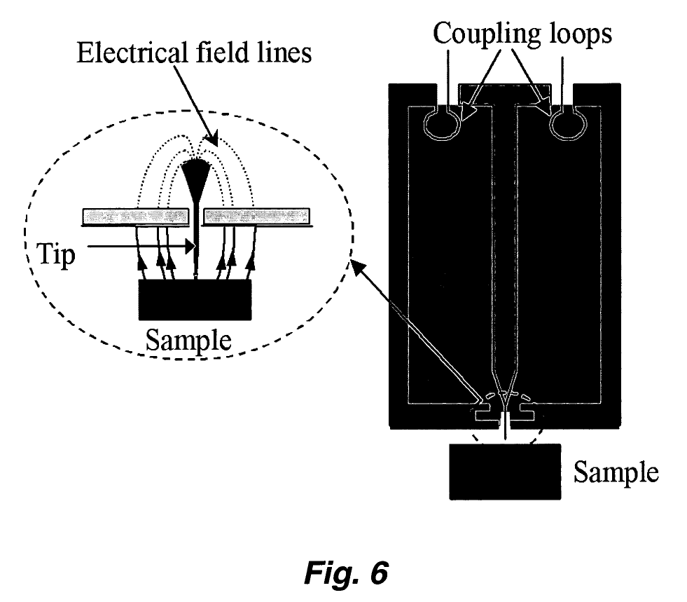

As illustrated in FIG. 6, the evanescent microwave probe is a highly sensitive spin resonance detection technique that operates by sending microwaves generated from a microwave resonator to a conducting tip/loop that is part of the evanescent microwave probe, which then sends evanescent microwaves into a sample. The results of that interaction are then detected by the same EWP tip/loop. Evanescent waves are generated by the EWP tip/loop because the tip/loop radius is much less than the wavelength of the microwaves in question. This interaction between the sample and the evanescent microwaves delivered from the EWP tip/loop depend on the complex electrical-magnetic impedance of the sample. The interaction depends on both the real and the imaginary parts of the impedance, and thus there are changes in resonant frequency (fᵣ) and quality factor (Q) of the resonator. Therefore EWP can simultaneously measure both the real and imaginary parts of the sample's electrical impedance, spin resonance properties, as well as the surface topography, by detecting the shift in resonance frequency and quality factor of the resonator as a result of the interaction. It will be understood by those skilled in the art that evanescent waves, also known as near-field waves, differ from far-field waves in that evanescent waves do not radiate or propagate in space, and are localized to (and only present near) the surface of the sharp, conducting EWP tip/loop. Evanescent (near-field) waves have a much higher spatial resolution than propagating (far-field) waves, and the enhanced resolution is on the order of the EWP tip/loop radius. The evanescent waves mentioned here may have energy in either the RF or microwave region of the spectrum.

IV. In Vitro Assays.

In addition to in vivo imaging applications, the ESR endohedral fullerene spin labels of this invention can be used to replace currently existing reporters in essentially any assay. Such assays include, but are not limited to various immunoassays (e.g., an ELIZA, a Western blot, immunohistochemistry, immunochromatography), electrophoresis (e.g., capillary electrophoresis), HPLC, and the like. In certain embodiments, the method involves measuring the level of a nucleic acid. Typically this involves hybridizing a fullerene spin-labeled nucleic acid probe to a target nucleic acid (e.g., in a Northern blot, an array hybridization, affinity chromatography, an in situ hybridization, and the like).

V. Imaging Reagents for Administration to Mammals.

The endohedral fullerene spin labels or endohedral fullerene spin labels attached to targeting moieties of this invention (particularly those specific for cancer or other pathologic cells) can be useful for parenteral, topical, oral, or local administration (e.g. injected into a tumor site), aerosol administration, and the like. The imaging compositions can be administered in a variety of unit dosage forms depending upon the method of administration. For example, unit dosage forms suitable for oral administration include powder, tablets, pills, capsules and lozenges. It is recognized that imaging compositions of this invention, when administered orally, can be protected from digestion. This is typically accomplished either by complexing the active component (e.g. the targeting moiety and/or endohedral fullerene spin labels) with a composition to render it resistant to acidic and enzymatic hydrolysis or by packaging the active ingredient(s) in an appropriately resistant carrier such as a liposome. Means of protecting components from digestion are well known in the art.

The imaging compositions of this invention are particularly useful for parenteral administration, such as intravenous administration or administration into a body cavity or lumen of an organ. The compositions for administration will commonly comprise a solution of the endohedral fullerene spin labels and/or endohedral fullerene spin labels attached to targeting moieties dissolved in a pharmaceutically acceptable carrier, preferably an aqueous carrier. A variety of aqueous carriers can be used, e.g., buffered saline and the like. These solutions are sterile and generally free of undesirable matter. These compositions can be sterilized by conventional, well known sterilization techniques. The compositions may contain pharmaceutically acceptable auxiliary substances as required to approximate physiological conditions such as pH adjusting and buffering agents, toxicity adjusting agents and the like, for example, sodium acetate, sodium chloride, potassium chloride, calcium chloride, sodium lactate and the like. The concentration of endohedral fullerene spin labels in these formulations can vary widely, and will be selected primarily based on fluid volumes, viscosities, body weight and the like in accordance with the particular mode of administration selected and the patient's needs.

It will be appreciated by one of skill in the art that there are some regions that are not heavily vascularized or that are protected by cells joined by tight junctions and/or active transport mechanisms which reduce or prevent the entry of macromolecules present in the blood stream

One of skill in the art will appreciate that in these instances, the imaging compositions of this invention can be administered directly to the site. Thus, for example, brain tumors can be visualized by administering the imaging composition directly to the tumor site (e.g., through a surgically implanted catheter).

VI. Kits.

In various embodiments, kits are provided for the practice of this invention. The kits can comprise one or more containers containing endohedral fullerene spin labels as described herein. The endohedral fullerene spin labels can optionally be derivatized, e.g. for attachment to a targeting moiety. In certain embodiments, the endohedral fullerene spin labels are provided already attached to a targeting moiety. In certain embodiments, the endohedral fullerene spin labels and targeting moieties are provided separately and the kit further contains reagents for coupling targeting moieties to the endohedral fullerene spin labels. The kit is preferably designed so that the manipulations necessary to perform the desired reaction should be as simple as possible to enable the user to prepare from the kit the desired composition by using the facilities that are at his disposal. Therefore the invention also relates to a kit for preparing a composition according to this invention. In certain embodiments, the kit can optionally, additionally comprise a reducing agent and/or, if desired, a chelator, and/or instructions for use of the composition and/or a prescription for reacting the ingredients of the kit to form the desired product(s). If desired, the ingredients of the kit may be combined, provided they are compatible.

In certain embodiments, the kit components (e.g., endohedral fullerene spin labels) they are preferably sterile and can, optionally be provided in a pharmacologically acceptable excipient. When the constituent(s) are provided in a dry state, the user should preferably use a sterile physiological saline solution as a solvent. If desired, the constituent(s) can be stabilized in the conventional manner with suitable stabilizers, for example, ascorbic acid, gentisic acid or salts of these acids, or they may comprise other auxiliary agents, for example, fillers, such as glucose, lactose, mannitol, and the like.

In certain embodiments, the kits additionally comprise instructional materials teaching the use of the compositions described herein (e.g., endohedral fullerene spin labels, derivatized endohedral fullerene spin labels, etc.) in electron spin resonance applications for selectively imaging cells, tissue, organs, and the like.

While the instructional materials, when present, typically comprise written or printed materials they are not limited to such. Any medium capable of storing such instructions and communicating them to an end user is contemplated by this invention. Such media include, but are not limited to electronic storage media (e.g., magnetic discs, tapes, cartridges, chips), optical media (e.g., CD ROM), and the like. Such media may include addresses to internet sites that provide such instructional materials.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A composition comprising an electron spin label, said label comprising a paramagnetic material caged within a fullerene.

2. The composition of claim 1, wherein said paramagnetic material caged within a fullerene has the formula
X@Cₙ
wherein:
X is said paramagnetic material; and
n is selected from the group consisting of 60, 70, 82, 84, 92, and 106.

3. The composition of claim 2, wherein X comprises a material that has an electron spin resonance (ESR) Q greater than 10, when caged within said fullerene.

4. The composition of claim 2, wherein X comprises a material that has an electron spin resonance (ESR) Q ranging from about 100 to about 1000 when caged within said fullerene.

5. The composition of claim 2, wherein X is selected from the group consisting of N, P, As, and a lanthanide.

6. The composition of claim 1, wherein:
said composition further comprises a targeting moiety attached to said fullerene;
said targeting moiety is attached to said fullerene through a linker.
said fullerene is attached to one or more targeting moieties.
said targeting moiety is selected from the group consisting of a protein, an antibody, a lectin, a saccharide, a vitamin, a steroid, a steroid analogue, a hormone, and a nucleic acid.

7-11. (canceled)

12. The composition of claim 6, wherein said targeting moiety specifically binds to a cell or tissue.

13. (canceled)

14. The composition of claim 12, wherein said targeting moiety is a protein or antibody.

15. (canceled)

16. The composition of claim 6, wherein said targeting moiety specifically binds to a a cancer marker selected from the group consisting of Caf-1, C-myc, p53, Ki67, Her2, Her4, BRCA1, BRCA2, Lewis Y (Le^{Y}), CA 15-3, G250, HLA-DR cell surface antigen, CEA, CD20, CD22, integrin, cea, 16, EGFr, AR, PSA, and other growth factor receptors.

17. (canceled)

18. The composition of claim 1, wherein said fullerene is in a pharmacologically acceptable excipient.

19. The composition of claim 2, wherein X is selected from the group consisting of:
nitrogen; galdolinium; not nitrogen; not galdolinium.

20-22. (canceled)

23. The composition of claim 2, wherein said fullerene cages a single atom.

24. The composition of claim 2, wherein said fullerene cages two atoms.

25. The composition of claim 2, wherein said fullerene cages three atoms.

26. A method of detecting a cell or tissue, said method comprising:
